(19) United States
(12) Patent Application Publication
(10) Pub. No.: US 2016/0138747 A1
(43) Pub. Date: May 19, 2016

(54) SYSTEM FOR CUTTING A WORKPIECE AND METHOD FOR THE SAME

(71) Applicant: Johnny Butler, Highlands, TX (US)

(72) Inventor: Johnny Butler, Highlands, TX (US)

(21) Appl. No.: 14/898,761

(22) PCT Filed: Jun. 18, 2014
(86) PCT No.: PCT/US2014/043030

§ 371 Date: Dec. 16, 2015

Related U.S. Application Data
(60) Provisional application No. 61/842,039, filed on Jul. 2, 2013.

(51) Int. Cl. F16L 41/06; B26F 1/00

(52) U.S. Cl. CPC F16L 41/06; B26F 1/0023

(57) ABSTRACT

A method for cutting a workpiece that includes positioning a first element proximate to an outer surface of the workpiece; operatively associating the first element with a cutting machine; operating the cutting machine to cutout a portion of the workpiece in an area where the first element is positioned; and removing the portion of the workpiece while the portion is in connection or mechanical communication with at least one of the first element and the cutting machine.

### BACKGROUND

1. Field of the Disclosure

This disclosure generally relates to systems and methods for cutting a workpiece. More particularly, the disclosure relates to a hot tap process for cutting an opening in a pipe, and retaining the cut portion after cutting the opening.

2. Background of the Disclosure

In the modern world it is axiomatic as to the extensive necessity for pipes or pipelines that are used to supply fluids both for residential and industrial purposes. These fluids may be liquid or gas, with common examples being water and natural gas. The pipe and fluid may be pressurized.

On occasion it becomes necessary to change the pipe network or configuration in some manner, which may be dictated by increased demand (and hence increased flow) or environmental factors. The need thus follows to add a new service tap on to a segment of the pipe, which may be safely done by removing any process fluid from the pipe and/or and disconnecting the applicable pipe segment from the network. However, in some instances it is inconvenient to shut down the process flow running through the pipe during such an operation, as doing so would cut off service to those connected with that particular part of the pipe network. In the production sense, stopping production is unfavorable because of the expense and loss of production incurred.

Accordingly, it is well known in the art to undertake a “hot tap” procedure, which essentially provides for maintaining some amount of process flow while cutting through (and removing) a portion of the pipe resulting in an opening therein. The process of hot tapping into a “live” pipe is an unsafe event that requires operational skill and machine safety to prevent the release of the process flow to the atmosphere, fire, or explosion. Once the hot tap is completed, a new process line or branch can be connected to the pipe, and the requisite change in flow can occur therethrough.

FIGS. 1A-1D together illustrate a typical hot tap process. During the process a pipe 100 (partial view) will have a process flow F running through it. As shown, a “saddle” 102 or the like may be positioned onto the pipe 100 in a secure manner. The saddle 102 usually has some form of a flange or flange connection 101 suitable for connection to a hot tap machine 106 or an intermediate valve (such as a gate or plug valve) 104.

The hot tap machine 106 is connected (e.g., bolted or other suitable form of attachment) to the valve 104, where the components are configured in a manner that allows a shaft 108 and cutter (e.g., hole saw) 110 to fit through the valve 104 and the saddle 102 in order to make cutting contact with an outer surface 114 of the pipe 100. Although not shown here, the hot tap machine 106 is often powered by a rotational motor that can be electric, pneumatic, hydraulic, etc., as well as a mechanism analogous to a drill press (such as a lever or spindle). The motor provides rotary capability to the shaft 108, while the mechanism provides for axial movement (e.g., up and down) for the shaft 108.

Attached to an end 105 of the shaft 108 is the cutter 110. The cutter is typically a hole saw, and the end 105 is also typically configured with a pilot bit 112, which is used to provide alignment and make the initial penetration into the pipe 100 during the cutting process.

Once all requisite equipment is in place and tested for integrity, the hot tap process starts with the cutter 110 and bit 112 rotated at a given speed and driven down by aforementioned means to come into contact with the pipe 100. As the pilot bit 112 drills through the pipe 100, the cutter 110 moves into contact with the pipe 100 and eventually cuts a portion of pipe 116 (conventionally the “coupon” or plug) out of the pipe 100.

Unfortunately in addition to the danger factors associated with cutting a pipe while process flows therethrough (e.g., explosion or fire) is the major risk of losing the coupon 116. Loss of the coupon 116 into the process flow is significantly problematic because it easily and freely can enter downstream equipment and has the potential to cause catastrophic or costly, major damage to the plant process. This may result in complete shut down or significant flow reduction. Sometimes this may be mitigated by flow reduction prior to starting the hot tap process. The flow rate reduction is achieved by reducing throughput or capacity of the plant process. Ultimately then the true cost of a hot tap is a combination of the operational cost of the hot tap process itself, in addition to any loss of production for the term of the hot tap process.

The coupon 116 may be unretained for several reasons, such as too great of size or weight for the hot tap machine to retain, or mechanical failure or inability. More to the point the prior art has not provided a satisfactory or viable solution to the problem of coupon retention. One crude solution entails the pilot bit 112 fitted with a spring, clip, wire, or other form of bit piece 103 that is intended to retain the coupon 116 once it has been cut out from the pipe 100. However, in actual operation such devices are wholly inadequate and prone to routine failure.

Thus, there is a tremendous need in the art for methods and systems of cutting a pipe that provide for improved coupon retention.

### SUMMARY

Embodiments of the disclosure pertain to a method for cutting a workpiece that may include the steps of positioning a first element proximate to an outer surface of the workpiece; operatively associating the first element with a cutting machine; operating the cutting machine to cutout a portion of the workpiece in an area where the first element is positioned; and removing the portion of the workpiece while the portion is in connection or mechanical communication with at least one of the first element and the cutting machine.

The method may include fixedly connecting a second element to the other surface of the workpiece. The positioning the first element step may include coupling the first element and second element together. The workpiece may be selected from a group of items such as a pipe or a vessel. In aspects, fixedly connecting may include welding. The first element may be a cylindrical elongate member configured with at least one groove. The groove(s) may be configured for receiving one of an o-ring and a bias member. The second element may be a stud. In aspects, the stud may be a welded stud. In other aspects, the stud may be a threaded stud.

The cutting machine may be configured with a vacuum system. The portion of the workpiece may be or include a coupon. In aspects, the coupon may have a mass in the range of about 0.1 lbs to about 10 lbs. The method may include operating the vacuum system to pull a vacuum on the first element in the range of about 0.1 inches mercury to about 25 inches mercury.

The positioning the first element step may include fixedly connecting the first element to the outer surface of the workpiece. Operatively associating the first element with a cutting machine may further include centralizing alignment of the cutting machine with the first element. In aspects, the method may include disposing a coupler on the workpiece; connecting a valve to the coupler; and engaging the cutting machine with the valve. A process fluid may flow through the workpiece while performing the method.

Operating the cutting machine may include rotating a hole saw. The first element may be stationary while the hole saw rotates during cutting. In aspects, no hole is drilled or otherwise cut in the portion.

Other embodiments of the disclosure pertain to a system for cutting a workpiece that may include a motor configured to work a shaft; a cutter operatively connected to the drive shaft; and a second member configured for engagement to the workpiece, and for coupling the first element with the workpiece. The shaft may be configured to engage a first member. In aspects, during cutting the drive shaft and cutter may be movable, and the first member and second member may be stationary.

The system may include a cutting machine. The motor, shaft, and cutter may be part of the cutting machine. The system may be configured to for removal of a portion of the workpiece while the portion is in connection with at least one of the first element and the cutting machine. The system may further include a retainer mechanism.

The workpiece may be a pipe or a vessel. In aspects, the workpiece is a pipe.

The retainer system may be operable to provide a vacuum pulled on the first member in the range of about 0.1″ to about 25″.

Either one of the shaft or the first member may include one or more bias members.

The system may further include a coupling device disposed on the workpiece; a valve connected to the coupling device; a cutting machine attached to the valve.

In aspects, the cutting machine may be configured to rotate the shaft and the cutter. During system operation the first element may be stationary while the cutter rotates.

Yet other embodiments of the disclosure pertain to a hot tap system for cutting out a portion of a pipe that may include a coupling device connected to the pipe; a first member also connected to the pipe; and a hot tap machine coupled with the coupling device. The hot tap machine may include a shaft and a cutter. The shaft may be configured to align with and engage the first member. One of the hot tap machine, the first member, and combinations thereof may be configured with a retaining mechanism that provides retention on the portion of the pipe during cutting.

The hot tap machine may include a motor configured to rotate the shaft and cutter. In aspects, the portion of the pipe may be a coupon. The retainer mechanism may include one or more a bias members. One or more bias members may be disposed within the first member.

Yet other embodiments of the disclosure pertain to a method for cutting a pipe that may include positioning a first element proximate to an outer surface of the pipe; operatively associating the first element with a hot tap machine; operating the hot tap machine to cutout a coupon from the pipe in an area where the first element is positioned; and removing the coupon while the coupon is in connection with at least one of the first element and the cutting machine.

The method may include fixedly connecting a second member to the outer surface of the pipe. The method may also include coupling the first member to the second member. Fixedly connecting may include welding. The first element may be a cylindrical elongate member. The second element may include a stud.

The shaft may include a bias member. The first member may include a groove configured to receive the bias member. The first member may include at least one bias member. The may include a respective groove(s) configured to receive the at least one bias member.

The method may include disposing a saddle on the pipe; connecting a valve to the saddle; engaging the cutting machine with the valve. A process fluid may flow through the pipe while performing the method. Operating the cutting machine may rotate a hole saw, wherein the first element is stationary while the hole saw rotates during cutting, and wherein no hole is drilled in the coupon.

These and other embodiments, features and advantages will be apparent in the following detailed description and drawings.

### BRIEF DESCRIPTION OF THE DRAWING

A full understanding of embodiments disclosed herein is obtained from the detailed description of the disclosure presented herein below, and the accompanying drawings, which are given by way of illustration only and are not intended to be limitative of the present embodiments, and wherein:

FIGS. 1A-1D illustrate a conventional hot tap system;

FIG. 2 shows a side view of a system for cutting a workpiece in accordance with embodiments disclosed herein;

FIG. 3 shows a side component view of a cutting system configured to cut a workpiece in accordance with embodiments disclosed herein;

FIGS. 6A-6E show a side view of a cutting process with assembly sequence in accordance with embodiments disclosed herein;

FIG. 7 shows a side close-up component view of a retainer mechanism in accordance with embodiments disclosed herein;

FIGS. 8A-8D show various side close-up component views of retainer mechanism examples configured with a bias member in accordance with embodiments disclosed herein;

FIG. 9 shows a side close-up component view of a retainer mechanism configured with a vacuum in accordance with embodiments disclosed herein;

FIGS. 10A and 10B show side isometric views of various spring plunger configurations in accordance with embodiments disclosed herein; and

FIGS. 11A and 11B show side views of a first member and a second member in accordance with embodiments disclosed herein.

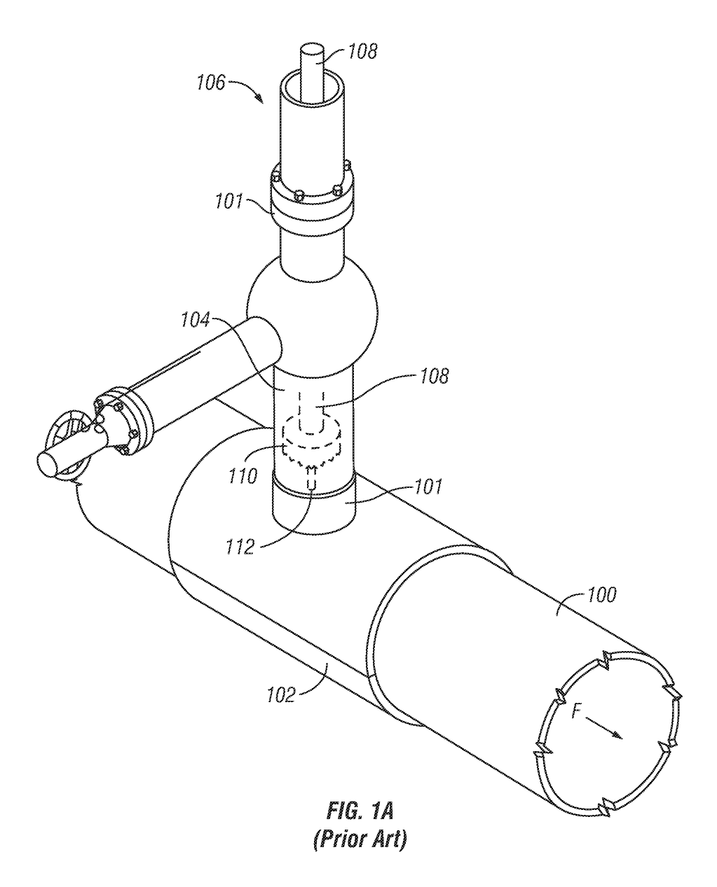

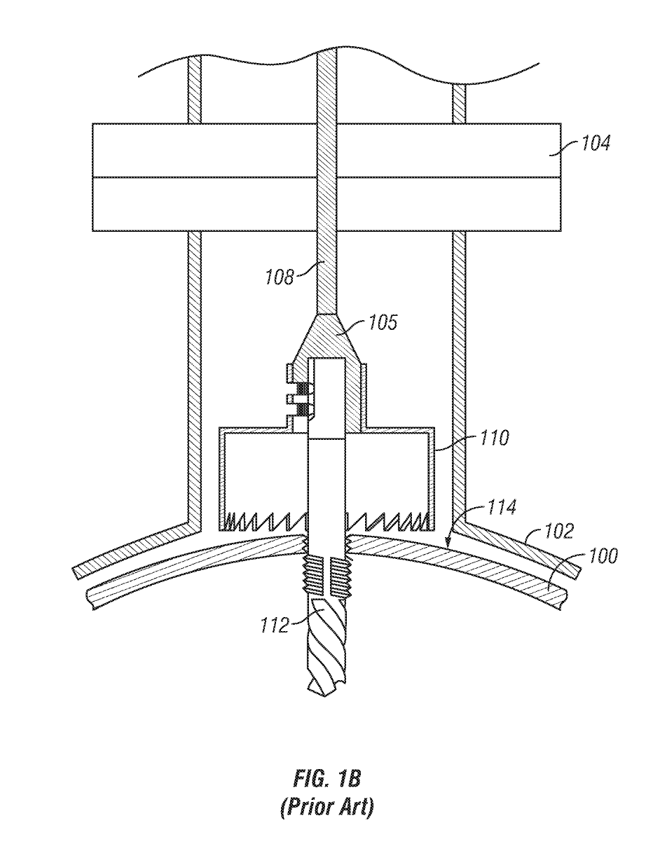

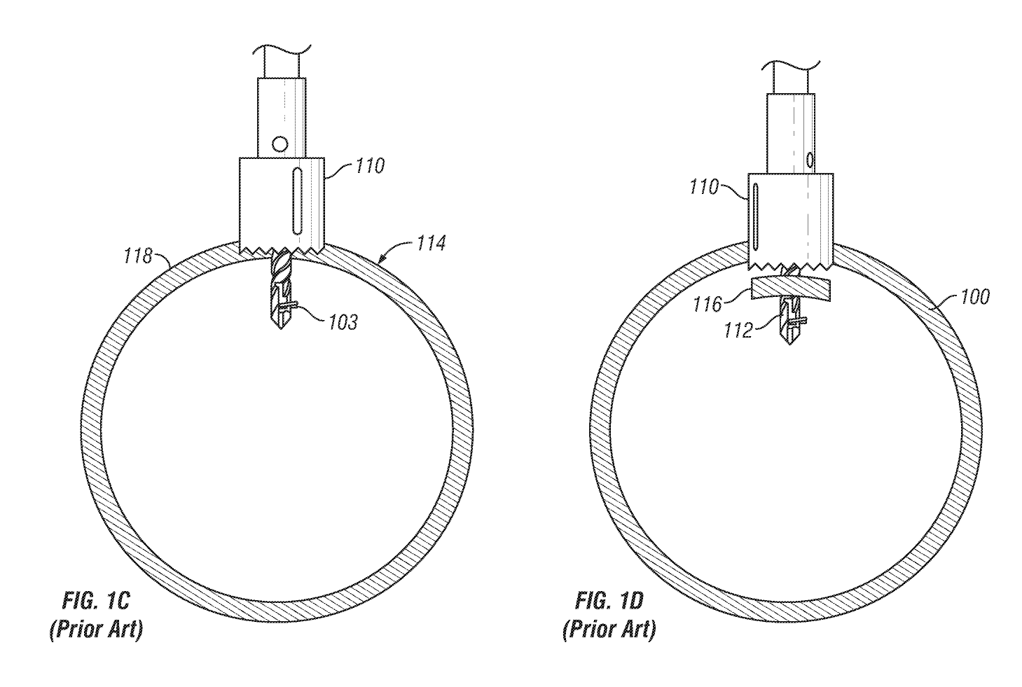

### DETAILED DESCRIPTION

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Although embodiments of the disclosure may reference a ‘pipe’, the disclosure is not limited, as embodiments may be suitable for other components, such as ducting, plastic tubing, non-pipe structures, atmospheric or pressure vessels, and the like. In that sense embodiments of the disclosure are applicable to any process where a cut or a cut opening in a workpiece is required or desired. A workpiece may be a structure that requires a cut or cutout, such as to form an opening. In a similar manner although the description may refer to a ‘hot tap’, embodiments of the disclosure are not meant to be limited as there is applicability to ‘cold tap’ or other cutting processes that result in a cut or cutout. Connection(s), couplings, or other forms of contact between parts and so forth may include conventional items, such as lubricant therebetween, additional sealing materials, such as a gasket between flanges, PTFE between threads, and the like. Embodiments of the disclosure provide for one or more components to be new, used, and/or retrofitted to existing machines and systems.

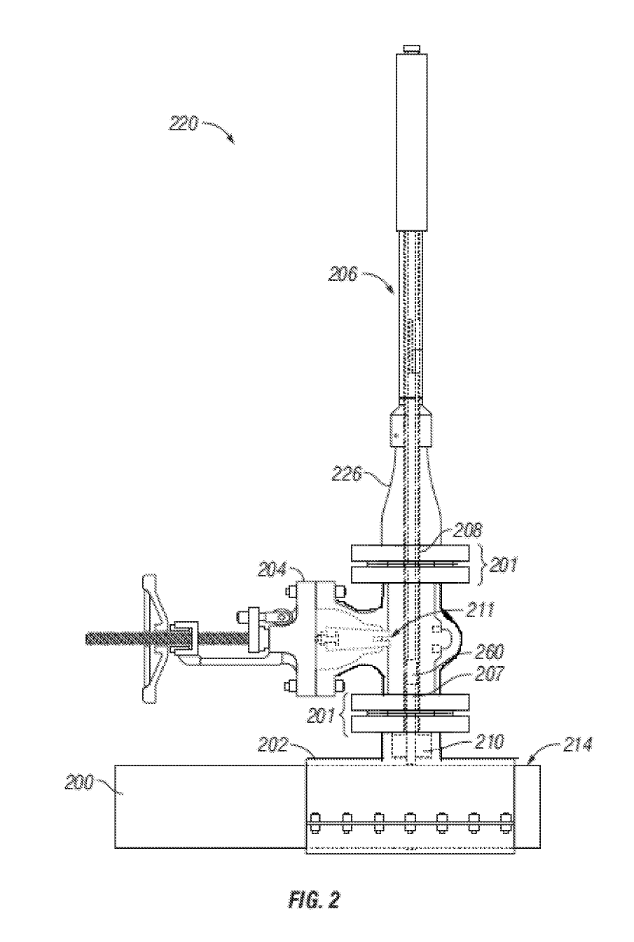

Referring now to FIG. 2, a side component view of a system 220 for cutting a workpiece according to embodiments of the present disclosure, is shown. The system 220 may be constructed of a number of interconnected and/or interoperable components, subcomponents, and so forth. Any of the components et al. may be constructed of materials, such as, steel, aluminum, rubbers, plastics, combinations thereof, or any other material of construction as would be apparent to one of skill in the art for cutting an applicable workpiece.

As shown in FIG. 2, the system 220 may incorporate use of a fixed mechanical attachment to the workpiece 200 via first member 207. The first member 207 may be positioned, disposed on, or otherwise coupled with the workpiece 200. In this sense, the first member 207 may be in mechanical communication or otherwise physically associated with the workpiece 200. The first member 207 may be an elongate member. In an embodiment the first member 207 may be a cylindrical elongate member.

The first member 207 may be used for alignment of a coupling device 202 attachment to the workpiece 200. The first member 207 may also provide longitudinal and latitudinal alignment for a machine shaft 208 (or machine 206). In this respect, the machine shaft 208 may be hollowed, at least partially, in order to fit down on and around the first member 207. The first member 207 may be a lone integral component, or it may be used in combination or connection with other pieces, such as a second member (not shown here). The first member 207 may be attached to the workpiece by known methods, such as threaded (e.g., threaded into the wall of the pipe without breaking into the pressurized interior of the pipe), welded, friction welded, electroweld, and the like. In embodiments the first member 207 is non-rotating while the shaft 208 rotates during operation of system 220. Accordingly, the shaft 208 may rotate around the stationary and fixed first member 207.

The coupling device 202, such as a tapping saddle or saddle valve (or just “saddle”), may fitted or secured to the workpiece 200. The coupling device 202 may be fitted with a flange or flange connection 201, other conventional form of mating attachment device (e.g., threads, etc.). A suitable coupling saddle structure is taught by U.S. Pat. No. 5,893,686, the entire disclosure of which is incorporated herein for all purposes. An example of a commercial coupling saddle suitable for embodiments herein is sold by the Ford Meter Box Company, Inc.

There may be an intermediate valve 204, which may be configured to control or contain process flow while penetration is made into the workpiece 200. The valve 204, such as a gate or ball valve, may be mated with the coupling device 202 via connection 201. Although not shown here, the coupling device 202 may include a valve configuration whereby use of intermediate valve 204 is unnecessary. For example, for a cold tap or non-pressurized cut (e.g., in non-hazardous environments).

The process to cut the workpiece 200 with system 220 may include turning (or positioning, operating, adjusting, etc.) the valve 204 to an open position 211 or a closed position (not shown here). As would be apparent to one of skill in the art, the closed position of a valve includes where flow is completely or substantially blocked from exiting or passing through the valve, and the open position (including partial open position) of the valve is essentially any non-closed position. The valve 204 may be moved to a suitable enough open position, whereby components of cutting machine 206 may pass therethrough. As such, in the open position 211 the shaft 208 and cutter 210 may be lowered therethrough (including onto and around first member 207), and ultimately into contact with an outer surface 214 of the workpiece 200. In embodiments, the cutter 210 may be a hole saw. In an embodiment, system 220 may be used in a hot tap operation. In embodiments, the workpiece 200 may be a pipe. Thus, the cutting machine 206 may be a ‘hot tap’ machine (such as for cutting a pipe); however, embodiments herein are not meant to be limited and other machines configured for cutting are within the scope of the disclosure. As shown, the cutting machine 206, and hence shaft 208, may be positioned approximately perpendicular to the workpiece 200 to enable ease of cutting.

The cutting machine 206 may be coupled with the valve 204. The shaft 208 may be passed (e.g., lowered) though the flange connection 201 between the machine 206 and valve 204. The system 220 and/or cutting machine 206 may include a retainer mechanism (designated as box 260 for illustration). “Mechanism” in this context may be a single device, a force, or combination of devices, moving parts, systems, subsystems, components, subcomponents, forces, and the like. In other embodiments, the first member 207 may include the retainer mechanism 260. In yet other embodiments, the proximity or engagement of the cutting machine (or components thereof) 206 with the first member 207 may form or otherwise result in the operability of the retainer mechanism 260.

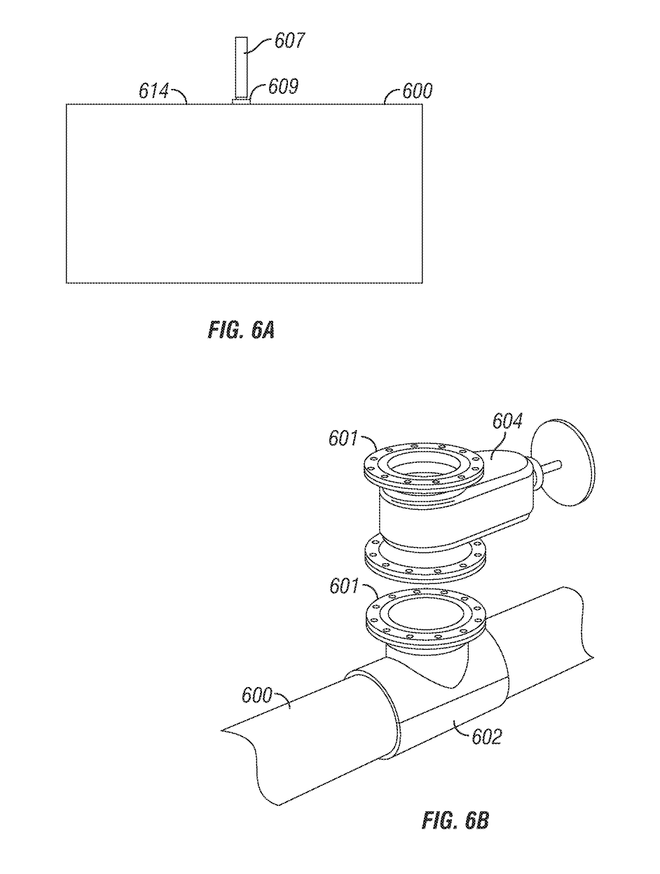

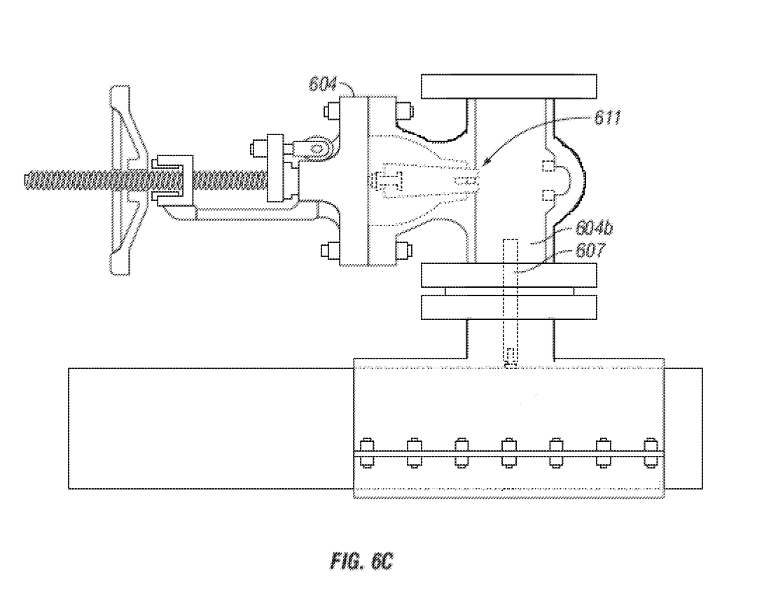

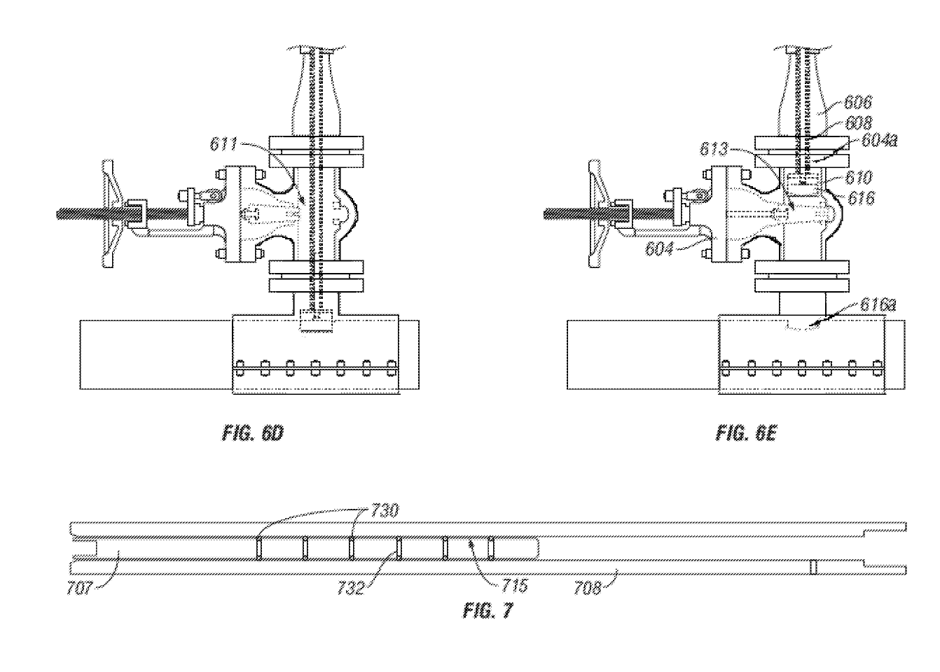

The retainer mechanism 260 provides the ability to maintain a retention force or capability on the workpiece portion (or soon-to-be formed workpiece portion) (see 616, FIG. 6E) while cutting occurs with system 220. For general understanding, this may be thought of as a sum of forces, where the retainer mechanism 260 provides for a greater force than other forces that may otherwise result in non-retention of the workpiece portion (e.g., gravity, etc.)

Once the cutter 210 penetrates and cuts the workpiece 200 in the desired manner, typically until cut out of the workpiece portion (616) is complete, it may be withdrawn back through device 202, valve 204, etc. and into machine housing 226. The valve 204 may be moved to the closed position, and the machine 206 removed therefrom (usually after ensuring any process fluid is cleared first).

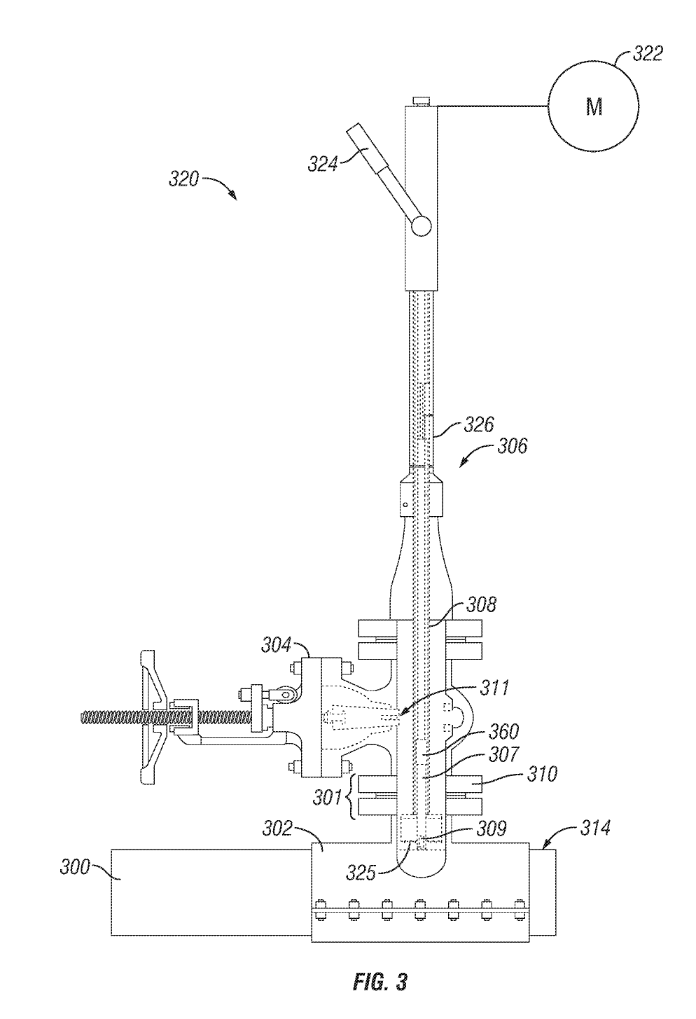

Referring now to FIG. 3, a side component view of a cutting system configured to cut a workpiece according to embodiments of the present disclosure, is shown. The system 320 may be constructed of a number of interconnected and/or interoperable components, subcomponents, and so forth. Like other system(s) described herein (e.g., system 220), the system 320 may be used for making a cut or a cutout in a workpiece, such as a pipe, vessel, etc. The system 320 may include similar components and materials of construction as described for other embodiments herein, such that there may be similarity or exactness between them, however, the systems need not be identical.

As shown in FIG. 3, the system 320 may incorporate use of a fixed or stationary attachment to the workpiece 300 that includes a first member 307. The first member 307 may be positioned, disposed on, or otherwise coupled with the workpiece 300. The first member 307 may be used or otherwise configured to align a coupling device 302 for attachment to the workpiece 300. The first member 307 may also provide alignment (e.g., longitudinal, latitudinal, rotational, etc.) for a machine shaft 308. In this respect, the machine shaft 308 may have a hollow region whereby the machine shaft 308 can fit and otherwise engage with, onto, and around the first member 307.

The first member 307 may be a lone integral component, or it may be used in combination or connection with other pieces, such as a second member 309. The first member 307 may be attached directly or indirectly to the workpiece 300 by known methods, such as threaded, welded, friction, welded, electroweld, and the like.

The second member 309 may be used for alignment base to center of the coupling device 302 attachment to the workpiece 300. This may also provide longitudinal and/or latitudinal alignment for the machine shaft 308. The second member 309 may be a stud, welded stud, threaded stud, etc. The second member 309 may be attached by known methods, such as threaded, welded, friction, welded, electroweld, and the like.

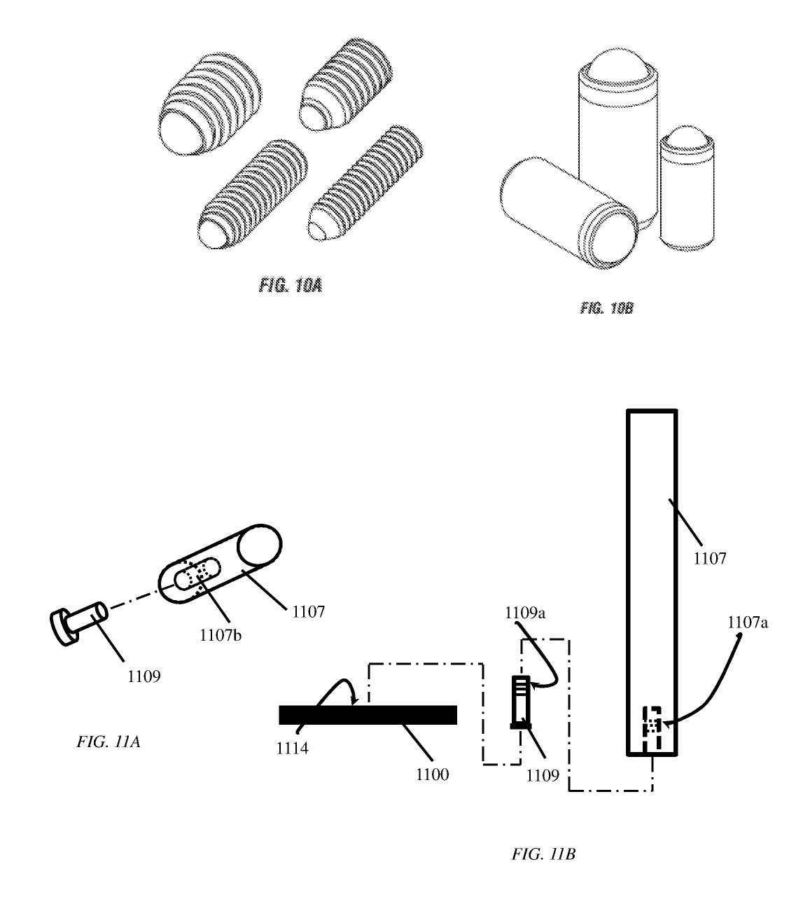

Referring briefly to FIGS. 11A and 11B together, an example of a first member 1107 and second member 1109 configuration is shown. The configuration is applicable to all embodiments of the disclosure. The first member 1107 and second member 1109 may be configured for engagement in any suitable method that enables a machine shaft (308) to rotate therearound, including, for example, press fit or threads. As such, first member 1107 may be configured with a receptacle 1109b suitable for engagement to the second member 1109. As shown in FIG. 11B, first member 1107 may have threads 1107a configured for mating with threads 1109a of the second member 1109. In an embodiment, the second member 1109 may be configured for fixed attachment to a workpiece 1100 at workpiece surface 1114. Although not limited: the first member 1107 may have a length in the range of about 4 inches to about 6 inches, and a diameter or width in the range of about 0.4 inches to 1 inch; the second member may have a length in the range of about 0.5 inches to about 1.5 inches, and a diameter or width in the range of about 0.1 inches to about 0.5 inches; the workpiece 1100 may have a workpiece wall thickness in the range of about 0.1 inches to about 0.75 inches.

Referring again to FIG. 3, the first member 307 and/or second member 309 may be made of material suitable for compatibility to the workpiece 300. The attachment of the members 307, 309 to the workpiece 300 may be quality tested, such as by torque or tensile testing. The members 307, 309 may be suitable for use as an alignment for shaft 308, saddle 302, cutting machine 306, valve 304, and combinations thereof.

The coupling device 302 (such as a “saddle”) may fitted or secured to the workpiece 300. The coupling device 302 may be fitted with a flange or flange connection 301, other conventional form of mating attachment device (e.g., threads, etc.). There may be an intermediate valve 304, such as a gate or ball valve, mated with the coupling device 302 via connection 301. Although not shown here, the coupling device 302 may include a valve configuration whereby use of intermediate valve 304 is unnecessary.

A cutting machine 306 (which may include housing 326) may be coupled with the valve 304. In embodiments, the cutting machine 306 may be a hot tap machine. The cutting machine 306 may be conventionally powered, such as pneumatically, hydraulically, electrically. In embodiments the cutting machine 306 may be powered in a manner providing safe use in otherwise flammable or hazardous environments. In embodiments, the cutting machine 306 may be manually powered, such as by crank. The machine 306 may be configured to accommodate interchangeable shafts, which may provide for the ability for insertion of a variety of shaft lengths and types (e.g., cutting thread tip, point tip, auger tip) to correspond to an array of workpiece physical restrictions and materials.

The shaft 308 may be passed though the flange connection 301 between the machine 306 and valve 304. System 320 and/or the cutting machine 306 may include a retainer mechanism 360. “Mechanism” in this context may be a single device, a force, or combination of devices, moving parts, systems, subsystems, components, subcomponents, forces, and the like. In other embodiments, the first member 307 may include the retainer mechanism 360. In yet other embodiments, the proximity or engagement of the cutting machine (or components thereof) 306 with the first member 307 may form or otherwise result in the operability of the retainer mechanism 360.

The retainer mechanism 360 provides the ability to maintain a retention force on the workpiece portion (or where the workpiece is being cut) (see 616, FIG. 6E) at the same time cutting occurs with system 320. The mechanism 360 may be an optimized tolerance fit between the first member 307 and shaft 308 that is configured for the shaft to rotate 308 (and/or cutter 310 to cut), but first member 307 and workpiece portion retained therein. Other aspects such as magnetic, electromagnetic, sealing, spring bias, energized, and so forth may be suitable for providing operability to mechanism 360.

Referring briefly to FIG. 7, a side close-up component view of a retainer mechanism example according to embodiments of the present disclosure, is shown. FIG. 7 illustrates an example of a sealing engagement retainer mechanism that includes sealing engagement between the first member 707 and shaft 708, such as with one or more sealing elements 730. A sealing element 730, such as an o-ring, may be disposed along first member 707. The first member 707 may have a groove (or seat, notch, etc.) 732 configured for the sealing element 730 to reside and/or maintain position therein. The first member 707 may have multiple grooves 732 and applicable sealing elements 730. In an embodiment, the first member 707 has between about 1 and 7 grooves 732 and corresponding sealing elements. In another embodiment, the first member 707 is configured with three grooves 732 and three corresponding sealing elements 730.

The sealing element 730 may sealingly engage or press the inner surface 715 of shaft 708. The sealing engagement may ensure fluids do not inadvertently pass into the cutting machine (e.g., 306, FIG. 3). In embodiments, the sealing engagement may ensure or otherwise aid in sealing or maintaining a vacuum within the cutting machine. The sealing element 730 material is not limited and may be any suitable sealing material, such as a rubber, a poly ether ether ketone (PEEK), polytetrafluoroethylene (PTFE), etc. One of skill in the art will, however, appreciate that other materials of construction are also contemplate, as well as a vice versa configuration (e.g., grooves and o-ring in shaft 708 sealingly engaging the first member 707).

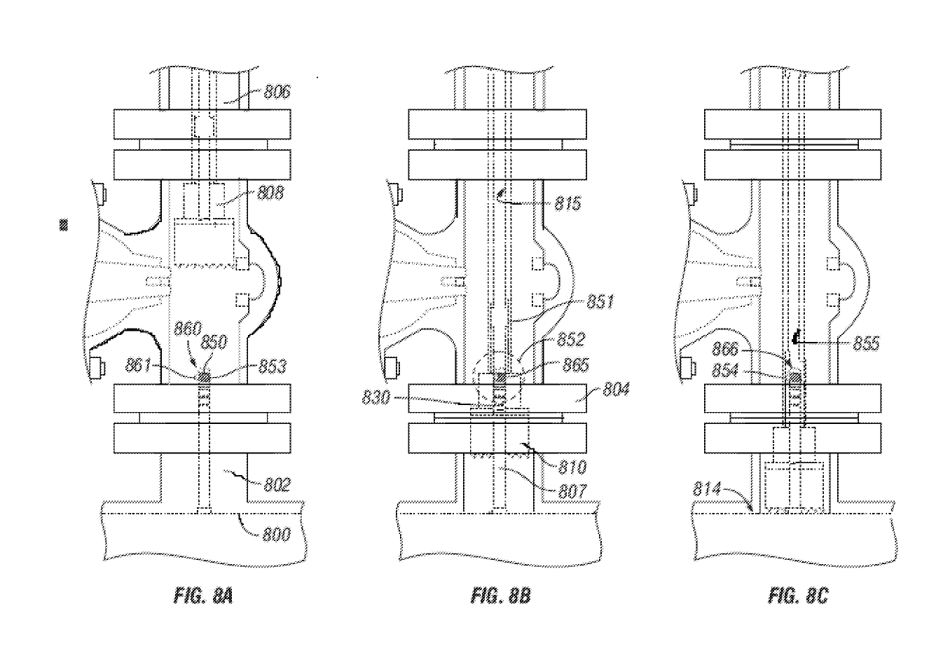

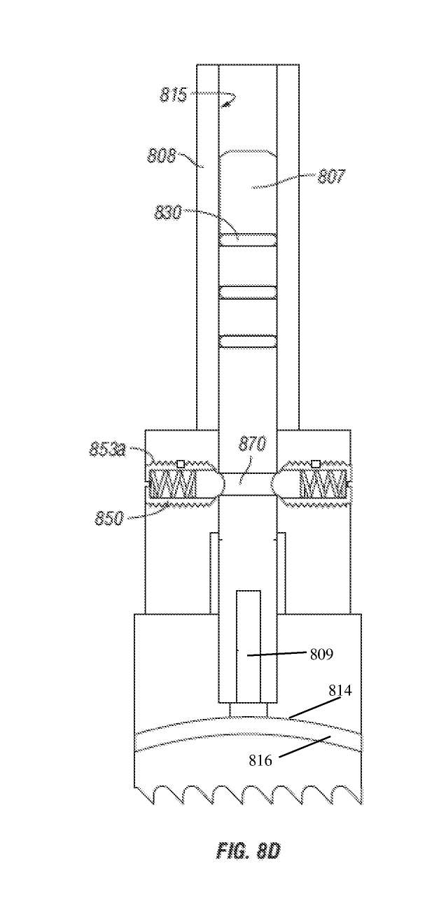

Referring briefly to FIG. 8A-8D, various side close-up component views of retainer mechanism examples configured with a bias member according to embodiments of the present disclosure, is shown.

FIGS. 8A-8C together illustrate the general connection of cutting machine 806, valve 804, coupler 802, and workpiece 800. The valve 804 may be moved to a suitable enough open position, whereby components of the cutting machine 806 may pass therethrough. As such, in the open position the shaft 808 and cutter 810 may be lowered therethrough (ultimately into contact with a surface 814 of workpiece 800). During operation, the shaft 808 may be movingly engaged with the first member 807, as shown in FIG. 8B. Thus, the shaft 808 may be configured with an internal hollow suitable to provide the shaft 808 the ability to move onto and around the first member 807.

The first member 807 may be configured with one or more bias members 850. As just one example, the first member 807 may be machined with a respective groove or notch 853, and the bias member 850 may be disposed (such as a fixed connection like a weld, threading, etc.) or otherwise fitted (such as press fit) in the groove 853. By way of example, the bias member 850 may be a spring plunger (see FIGS. 10A and 10B). FIG. 8A illustrates a generally deenergized position 860 of the bias member 850. FIG. 8B illustrates a generally energized position 852 as a result of shaft surface 815 engaging bias member segment 861. The segment 861 may be a subcomponent, such as a ball bearing, or other suitable reduced friction device or surface that allows the shaft 808 (and surface 815) to pass thereover and compress or energize the bias member 850 to position 852. The bias members 850 may be positioned in any position desired to achievement retainment of a part of the workpiece that is cut.

The shaft 808 may be hollow at least partially or through an extended length of the shaft 8080. The shaft 808 may be configured with a shaft groove 851. Accordingly, the shaft 808 cutting position (e.g., the cutter 810 engaged with workpiece 800) may coincide with the bias member 850 engaged with the groove 851. The engagement of the bias member 850 with the groove 851 may result in a partial energized (or de-energized) position 866 of the bias member 850 (e.g., partial compression of spring segment 865). There may be a plurality of grooves 851 and respective members 850.

Optionally, the shaft 808 may be sealingly engaged with the first member 807. In embodiments, the shaft 808 may be rotatingly engaged with the first member 807. As such, during cutting the shaft 808 may freely rotate, whereby cutter 810 cuts workpiece 800, while first member 807 remains fixed and stationary.

FIG. 8D illustrates a vice versa configuration where the cutting machine 806 may be configured with one or more bias members 850. The bias members may be positioned in any position desired to achievement retainment of a part of the workpiece that is cut. In an embodiment, the bias member(s) 850 may be disposed or otherwise fitted within a shaft groove or notch 853a. The bias members 850 may be disposed or arranged in or along the shaft 808 in any position desired to achievement retainment of a part of the workpiece that is cut. The shaft 808 may include one or more bias members 850 that engage a groove or receptacle 870 of the first member 807.

As FIGS. 8A-8D illustrate together, the first member 807 may include one or more sealing elements 830. The first member 807 may have a groove (or seat, notch, etc.) 832 configured for the sealing element 830 to reside and/or maintain position therein. The sealing element 830 may sealingly engage or press the inner surface 815 of shaft 808. One of skill in the art will appreciate the sealing element may be made of conventional materials of construction, as well as a vice versa configuration (e.g., grooves and o-ring in shaft 808 sealingly engaging the first member 807).

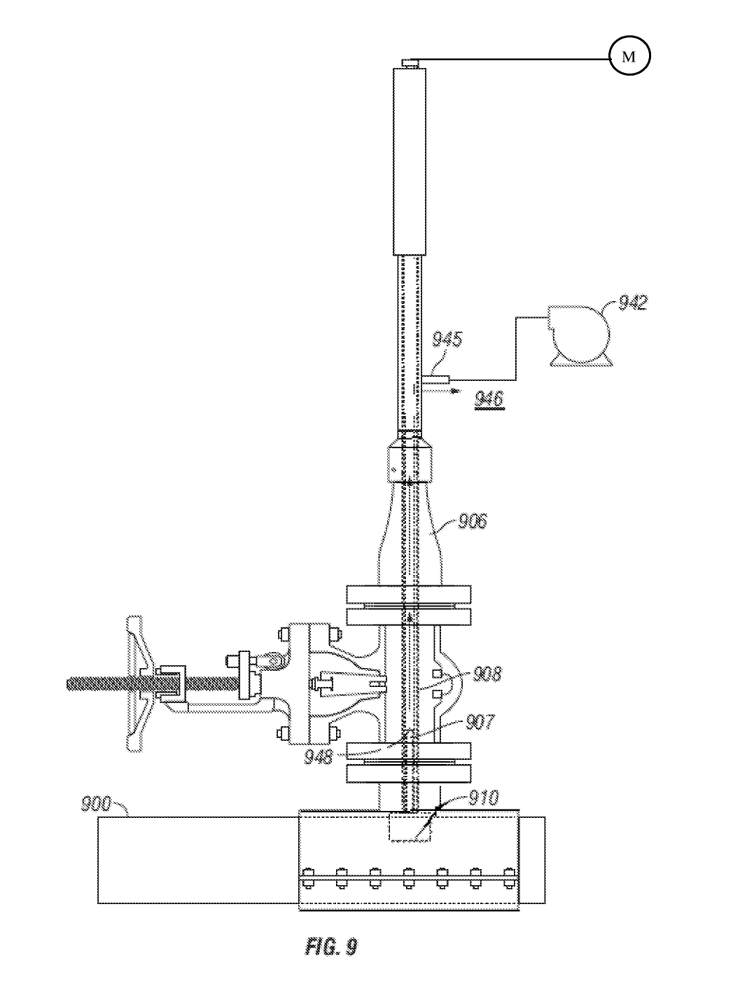

Referring briefly to FIG. 9, a side close-up component views of retainer mechanism example configured with a vacuum according to embodiments of the present disclosure, is shown. In embodiments, a vacuum may be operably associated or otherwise connected with the cutting machine 906. The vacuum need only be a pressure (or force) suitable enough to maintain direct or indirect retention of a workpiece portion (e.g., 616, FIG. 6E). As such, the vacuum may result from known components suitable to pull a vacuum, such as pump, eductor, and so forth. In embodiments, there may be a vacuum system 946, which may include a vacuum pump 942 and associated piping, nozzles, and so forth. In an embodiment, the vacuum is sufficient to retain a workpiece portion weight in the range of about 0.1 to about 7 lbs.

The pump 942 may be connected (such as fluidly connected) with housing nozzle or port 945. Operation of the pump 942 may result in a vacuum (or pulling) pressure on an area 948 of the first member 907. Any resultant vacuum may be released by opening a vent or bleed valve (not shown) associated with the cutting machine 906 or vacuum system 946.

The pump 942 may be configured and otherwise operably connected with the cutting machine 906 to secure and retain the first member 907) within the shaft 908, and resultant workpiece portion connected therewith. The shaft 908 may be re-positionable and otherwise movingly engaged with the first member 907. Movement of the shaft 908 may be by manual or automatic operation, and may be as a result of mechanical, hydraulic, pneumatic, and the like pressure (or force). Downward movement ultimately results in the engagement of cutter 910 with workpiece 900.

Referring again to FIG. 3, the cutter 310 may have conventional cutting teeth 325, but the cutter is not meant to be limited and need only be suitable for use on the workpiece being cut. Therefore, the cutter 310 may be designed and fabricated with appropriate teeth or other structure corresponding to the material and thickness of the workpiece to be cut. The cutter 310 may be interchangeable to allow replacement due to worn teeth or substituting alternative cutting members with different cutting diameters or different teeth specifications for a wide variety of applications.

During cutting, the shaft 308 may be moved axially toward the workpiece 300, whereby the cutter 310 may then engage and cut the workpiece 300. Sufficient pressure may be applied automatically or manually. The 310 may be a hole saw; however, embodiments of the disclosure are not limited to any particular cutter type. Instead, the cutter may be any component adaptable for cutting through a surface of a workpiece. Moreover, although the type of cut for a hot tap process is typically round or circular (e.g., a hole), embodiments of the disclosure are not limited to any particular type or shape of cutout. The workpiece portion (e.g., 616, FIG. 6E) may be sufficient in size and shape to be retained by embodiments described herein.

Upon sufficient completion of cutting, the workpiece portion may be removed by way of reverse axial movement of shaft 308 (as a result of retention mechanism 360 maintaining connection therewith). The cutting machine 306 may be decoupled and a branch pipe (not shown) attached in its place. The valve 304 may then be opened to fluidly connect the branch without altering pressure in pipe 300.

The cutting element 310 may rotate about the mutual rotational axis with the shaft 308 at a radius corresponding to the desired pipe opening diameter. The cutting element 310 may have an adjustable radial position, which may be moved or otherwise adjusted such that the same cutting element 310 may be used to cut wide range of circular opening diameters. The cutting element 310 or its members may be interchangeable to allow replacement of worn bits or substitution of alternative cutting bits for varying workpiece materials and configurations.

Referring briefly to FIGS. 6A-6E, various views of a cutting process and assembly sequence according to embodiments of the present disclosure, are shown. The description of the assembly sequence and cutting process may be applicable to all embodiments of the disclosure, including those discussed and/or obvious to one of skill in the art. FIG. 6A shows a first member 607 may be positioned, disposed on, or otherwise coupled onto an outer surface area 614 of a workpiece (partial view) 600. The first member 607 may be a single component, or it may be used in combination or connection with other pieces, such as a second member 609. In embodiments, the first member 607 may be attached directly or indirectly to the workpiece 600 by known methods, such as threaded, welded, friction welded, electroweld, and the like. In other embodiments, the second member 609 may be attached directly to the workpiece 600 by known methods, such as threaded, welded, friction welded, electroweld, and the like. The first member 607 may be coupled to the second member 609.

FIG. 6B shows a coupling device 602, such as a tapping saddle or saddle valve, may fitted or secured to the workpiece 600. The coupling device 602 may be fitted with a flange or flange connection 601, other conventional form of mating attachment device (e.g., threads, etc.). Once the coupling device 602 is in the desired position, an intermediate valve 604 may be mated therewith via connection 601. Although not shown here, the coupling device 602 may include a valve configuration whereby use of intermediate valve 604 is unnecessary. In other aspects, the valve 604 may be connected to the coupling device 602 before the coupling device 602 is attached to the workpiece 600. FIG. 6C illustrates the valve 604 in an open position 611. Although first member 607 is shown having a length sufficient to extend into an annular valve space 604b, the length is not meant to be limited and may instead be any length suitable for the applicable process.

FIG. 6D illustrates the cutting machine (partial view) 606, and hence shaft 608, may be positioned approximately perpendicular to the pipe 600 to enable ease of cutting. FIG. 6E illustrates the shaft 608, cutter 610, and coupon 616 being retracted into upper valve chamber 604a, whereby the valve 604 may be moved to the closed position 613, and cutting machine (partial view) 606 removed therefrom. A new branch line (not shown here) may then be attached and the valve 604 opened whereby fluid may now flow through opening 616a and into the new line accordingly.

Advantages.

Embodiments beneficially remove the need for use or requirement of a pilot drill bit. No flow rate reduction during the cutting process is required because the coupon is completely retained. Improved downstream reliability and safety after hot tap process.

With the coupon mechanically attached to the shaft of the hot tap machine, the risk of a lost coupon may be substantially reduced or removed altogether, greatly improving the hot tap process.

With the fixed, primary, center shaft, the coupon is mechanically coupled to the machine shaft and resultantly stay within the cutter. This prevents the coupon from coming into the flow turbulence of the process as well as prevents the coupon from spinning and detaching from the shaft. The travel of the outer shaft or housing can be designed to only travel a given distance, to provide the added safety factor of preventing the hole saw from cutting all the way through the pipe on both sides.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure presented herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of any claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A method for cutting a workpiece, the method comprising:
positioning a first element proximate to an outer surface of the workpiece;
associating the first element with a cutting machine;
operating the cutting machine to cutout a portion of the workpiece in an area where the first element is positioned; and
removing the portion of the workpiece from the workpiece while the portion is in mechanical communication with at least one of the first element and the cutting machine.

2. The method of claim 1, the method further comprising fixedly connecting a second element to the other surface of the workpiece,
wherein the positioning the first element step comprises coupling the first element and second element together, and wherein the workpiece is selected from a group consisting of a pipe and a vessel.

3. The method of claim 2, wherein fixedly connecting comprises welding, wherein the first element is an elongate member comprising at least one groove, and wherein the second element comprises a stud.

4. The method of claim 3, wherein the groove is configured for receiving one of an o-ring and a bias member.

5. The method of claim 3, wherein the cutting machine is configured with a vacuum system, wherein the portion of the workpiece comprises a coupon, wherein the coupon has a mass in the range of about 0.1 lbs to about 10 lbs, and the method further comprises operating the vacuum system to pull a vacuum on the first element in the range of about 0.1″ mercury to about 25″ mercury.

6. The method of claim 2, wherein fixedly connecting comprises welding, wherein the first member is a cylindrical elongate member comprising a bias member, wherein the shaft comprises a groove, and wherein the second element comprises a stud.

7. The method of claim 6, wherein the groove is configured to receive the bias member.

8. The method of claim 1, wherein the positioning the first element step comprises fixedly connecting the first element to the outer surface of the workpiece.

9. The method of claim 1, wherein associating the first element with a cutting machine further comprises centralizing alignment of the cutting machine with the first element.

10. The method of claim 9, the method further comprising:
disposing a coupler on the workpiece;
connecting a valve to the coupler; and
engaging the cutting machine with the valve, wherein a process fluid flows through the workpiece while performing the method.

11. The method of claim 1, wherein operating the cutting machine rotates a hole saw, wherein the first element is stationary while the hole saw rotates during cutting, and wherein no hole is drilled in the portion.

12. A system for cutting a workpiece, the system comprising:
a motor configured to work a shaft, wherein the shaft is configured to engage a first member;
a cutter operatively connected to the shaft;
a second member configured for engagement to the workpiece, and for coupling the first element in mechanical communication with the workpiece,
wherein during cutting the shaft and cutter are movable, and the first member and second member are stationary.

13. The system of claim 12, the system further comprising a cutting machine, wherein the motor, shaft, and cutter are part of the cutting machine, and wherein the system is configured to remove a portion of the workpiece while the portion is in connection with at least one of the first element, the second element, and the cutting machine.

14. The system of claim 13, wherein the workpiece is selected from a group consisting of a pipe and a vessel.

15. The system of claim 13, wherein the workpiece is a pipe, wherein the second member is a stud welded to the workpiece.

16. The system of claim 13, the system further comprising a retainer mechanism.

17. The system of claim 16, wherein the retainer mechanism comprises a vacuum pulled on the first member in the range of about 0.1″ mercury to about 25″ mercury.

18. The system of claim 12, wherein either one of the shaft or the first member comprise a bias member.

19. The system of claim 12, the system further comprising:
a coupling device disposed on the workpiece;
a valve connected to the coupling device; and
a cutting machine attached to the valve.

20. The system of claim 19, wherein the cutting machine is configured to rotate the shaft and the cutter, and wherein during operation the first element is stationary while cutter rotates.

21. A method for cutting a pipe, the method comprising:
positioning a first element proximate to an outer surface of the pipe;
associating the first element with a hot tap machine;
operating the hot tap machine to cutout a coupon from the pipe in an area where the first element is positioned; and
removing the coupon while the coupon is mechanically associated with at least one of the first element and the cutting machine.

22. The method of claim 21, the method further comprising fixedly connecting a second member to the outer surface of the pipe, and coupling the first member to the second member.

23. The method of claim 22, wherein fixedly connecting comprises welding, wherein the first element is a cylindrical elongate member, and wherein the second element comprises a stud.

24. The method of claim 22, wherein fixedly connecting comprises welding, wherein the second element comprises a stud, wherein the shaft comprises a bias member, and wherein the first member is an elongate member comprising a groove configured to receive the bias member.

25. The method of claim 22, wherein fixedly connecting comprises welding, wherein the second element comprises a stud, wherein the first member comprises a bias member, and wherein the shaft comprises a groove configured to receive the bias member.

26. The method of claim 21, the method further comprising:
disposing a saddle on the pipe;
connecting a valve to the saddle; and
engaging the cutting machine with the valve,
wherein a process fluid flows through the pipe while performing the method, wherein operating the cutting machine rotates a hole saw, wherein the first element is stationary while the hole saw rotates during cutting, and wherein no hole is drilled in the coupon.
